(19) United States
(12) Patent Application Publication
(10) Pub. No.: US 2010/0245039 A1
(43) Pub. Date: Sep. 30, 2010

(54) Mobile unit

(75) Inventor: Yuki Tokunaga, Obu-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/661,744

(22) Filed: Mar. 23, 2010

(30) Foreign Application Priority Data
Mar. 25, 2009 (JP) 2009-075027

(51) Int. Cl. G05B 19/00

(52) U.S. Cl. 340/5.61

(57) ABSTRACT

A mobile unit includes a LF antenna having a predetermined receiving frequency band and gain to receive a LF signal, a determination circuit for determining whether the LF signal received by the LF antenna is an authorized LF signal, a controller activated in response to a determination by the determination circuit that the LF signal received by the LF antenna is the authorized LF signal, a damping resistor connected to the LF antenna, a switch for enabling and disabling the damping resistor, and an antenna gain adjuster for reducing the gain of the LF antenna in response to a determination by the determination circuit that the LF signal received by the LF antenna is different from the authorized LF signal by controlling the switch in such a manner that the damping resistor is enabled.

### CROSS REFERENCE TO RELATED APPLICATION

This application is based on and incorporates herein by reference Japanese Patent Application No. 2009-75027 filed on Mar. 25, 2009.

### FIELD OF THE INVENTION

The present invention relates to a mobile unit that responds to a low frequency signal.

### BACKGROUND OF THE INVENTION

Conventionally, there has been proposed a smart entry system for locking and unlocking a door of a vehicle without an operation of a mobile key. Specifically, when an user of the vehicle carrying the mobile unit approaches the door and operates a door unlock button on the vehicle, a request signal is transmitted from the vehicle. In response to the request signal, the mobile unit transmits a response signal containing an identification (ID) code of the mobile unit. Upon reception of the response signal, the vehicle determines whether there is a match between the ID code contained in the received response signal and an ID code prestored in the vehicle. If there is a match between the ID codes, the door is unlocked. Further, when the user operates a door lock button on the vehicle, the vehicle locks the door. In this way, the smart entry system allows the user to lock and unlock the door of the vehicle without operating the mobile key.

As described in, for example, JP-2007-36761A, in a typical smart entry system, a low frequency (LF) radio wave is used to transmit a signal from a vehicle to a mobile unit, and a radio frequency (RF) radio wave is used to transmit a signal from the mobile unit to the vehicle. Specifically, a controller of a mobile unit (hereinafter called a “smart mobile unit”) in a typical, smart entry system is activated by a LF signal, and the activated controller transmits a RF signal to the vehicle.

However, there is a possibility that noise of a LF band emitted by electronic devices mounted in or near an occupant compartment of the vehicle causes the controller of the smart mobile unit to malfunction. That is, the controller of the smart mobile unit may misinterpret the LF noise as an authorized LF signal and accidentally activated by the LF noise. The smart mobile unit cannot receive the authorized LF signal during malfunction. Further, if the smart mobile unit repeatedly malfunctions, a battery of the smart mobile is greatly reduced.

### SUMMARY OF THE INVENTION

In view of the above, it is an object of the present invention to provide a mobile unit that is less likely to malfunction due to noise.

According to an aspect of a present invention, a mobile unit includes a LF antenna, a determination circuit, a controller, a damping resistor, a switch, and an antenna gain adjuster. The LF antenna has a predetermined receiving frequency band and a predetermined gain to receive a LF signal. The determination circuit determines whether the LF signal received by the LF antenna is an authorized LF signal. The controller is activated, when the determination circuit determines the LF signal received by the LF antenna is the authorized LF signal. The damping resistor is connected to the LF antenna. The switch enables and disables the damping resistor. The antenna gain adjuster reduces the gain of the LF antenna by controlling the switch in such a manner that the damping resistor is enabled, when the determination circuit determines that the LF signal received by the LF antenna is different from the authorized LF signal.

### BRIEF DESCRIPTION OF THE DRAWINGS

The above and other objectives, features and advantages of the present invention will become more apparent from the following detailed description made with check to the accompanying drawings. In the drawings:

FIG. 1 is a block diagram of a smart mobile unit according to a first embodiment of the present invention;

FIG. 2 is a flow diagram of a process performed by a receiver IC of the smart mobile unit of FIG. 1;

FIG. 3 is a diagram illustrating a difference of a receiving frequency band of a LF antenna of the smart mobile unit of FIG. 1 between when a damping resistor is enabled and when the damping resistor is disabled; and

FIG. 4 is a block diagram of a smart mobile unit according to a second embodiment of the present invention.

### DETAILED DESCRIPTION OF THE PREFERRED EMBODIMENTS

### First Embodiment

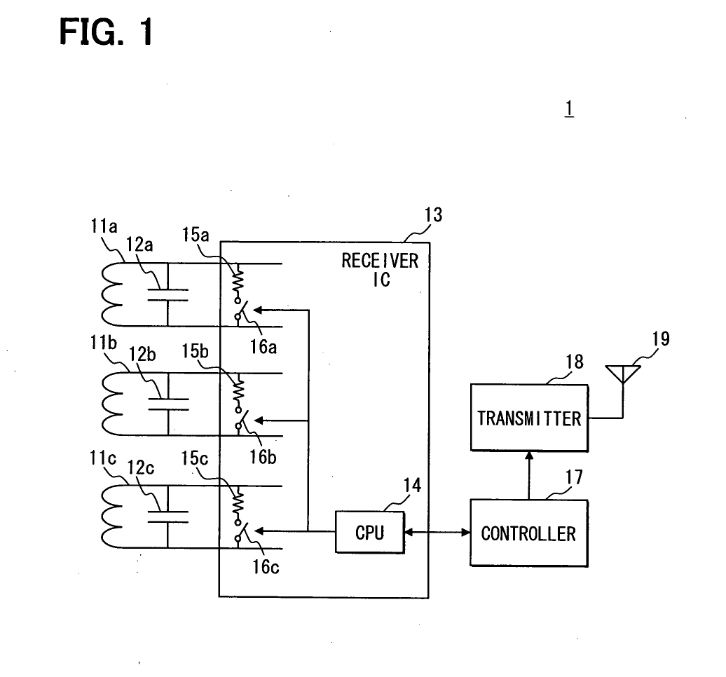

A smart mobile unit 1 according to a first embodiment of the present invention is described below with reference to FIG. 1. The smart mobile unit 1 is used in a smart entry system that allows a door of a vehicle to be looked and unlocked without a mechanical key.

In the smart entry system, when a user of the vehicle carrying the smart mobile unit 1 approaches the door of the vehicle, the smart mobile unit 1 receives a request signal transmitted from the vehicle. Upon reception of the request signal from the vehicle, the smart mobile unit 1 transmits a response signal containing an identification (ID) code specific to the smart mobile unit 1. The ID code of the smart mobile unit 1 is prestored in the smart mobile unit 1. Upon reception of the response signal from the smart mobile unit 1, the vehicle determines whether there is a match between the ID code of the smart mobile unit 1 and an ID code specific to the vehicle. If the user carrying the smart mobile unit 1 moves away from the vehicle by a predetermined distance, the vehicle cannot receive the response signal from the smart mobile unit 1. When the vehicle becomes incapable of receiving the response signal, the vehicle locks the door. In this way, the user carrying the smart mobile unit 1 can lock and unlock the door of the vehicle without touching the vehicle. It is noted that the request signal is a low frequency (LF) signal and that the response signal is a radio frequency (RF) signal. For example, the LF signal can have a frequency of about 134 kHz. The request signal is hereinafter sometimes called a “LF signal”. It is noted that the wireless communication performed between the smart mobile unit 1 and the vehicle to lock and unlock the door according to the result of the ID code matching is middle-range wireless communication up to several meters.

As shown in FIG. 1, the smart mobile unit 1 includes a X-axis antenna 11a, a Y-axis antenna 11b, a Z-axis antenna 11c, capacitors 12a-12c, a receiver integrated circuit (IC) 13, a controller 17, a transmitter 18, and a transmitting antenna 19.

Each of the X-axis antenna 11a, the Y-axis antenna 11b, and the Z-axis antenna 11c has a predetermined receiving frequency band and a predetermined gain to receive the LF signal. Each of the X-axis antenna 11a, the Y-axis antenna 11b, and the Z-axis antenna 11c is hereinafter sometimes called a “LF antenna”. The X-axis antenna 11a, the Y-axis antenna 11b, and the Z-axis antenna 11c are directed to different directions so that the smart mobile unit 1 can receive a signal (e.g., radio wave) coming from any direction. For example, the X-axis antenna 11a, the Y-axis antenna 11b, and the Z-axis antenna 11c can be directed perpendicular to each other. The signal received by the LF antenna is transmitted to the receiver IC 13. The receiving frequency band of the LF antenna is adjusted to have a peak at 134.2 kHz corresponding to a frequency of the LF signal. Further, a full width at half maximum (FWHM) of the peak is about 4 kHz. The gain of the LF antenna is set by default to a value that allows the LF antenna to surely receive an authorized LF signal. For example, the gain of the LF antenna can be set by default substantially equal to a gain of a LF antenna of a typical smart mobile unit.

The capacitors 12a-12c are connected to the X-axis antenna 11a, the Y-axis antenna 11b, and the Z-axis antenna 11c to form parallel resonance circuits, respectively. Specifically, the capacitor 12a is connected to the X-axis antenna 11a to form a parallel resonance circuit, the capacitor 12b is connected to the Y-axis antenna 11b to form a parallel resonance circuit, and the capacitor 12c is connected to the Z-axis antenna 11c to form a parallel resonance circuit. Each of the capacitors 12a-12c can have a fixed capacitance. Alternatively, each of the capacitors 12a-12c can have a variable capacitance. Resonance frequencies of the X-axis antenna 11a, the Y-axis antenna 11b, and the Z-axis antenna 11c can be changed by changing the capacitances of the capacitors 12a-12c, respectively. The receiving frequency bands of the X-axis antenna 11a, the Y-axis antenna 11b, and the Z-axis antenna 11c can be adjusted by changing the resonance frequencies, respectively. For example, the receiver IC 13 can outputs a command signal for changing the capacitances of the capacitors 12a-12c.

The receiver IC 13 includes a central processing unit (CPU) 14, damping resistors 15a-15c, and switches 16a-16c. Components of the receiver IC 13 other than the CPU 14, the damping resistors 15a-15c, and the switches 16a-16c can be the same as those of a receiver IC of a typical smart mobile unit.

The damping resistors 15a-15c are electrical resistors and connected in parallel to the parallel resonance circuits to reduce quality (Q) factors of the parallel resonance circuits, respectively. In other words, the damping resistors 15a-15c reduce Q factors of the X-axis antenna 11a, the Y-axis antenna 11b, and the Z-axis antenna 11c, thereby reducing the gains of the X-axis antenna 11a, the Y-axis antenna 11b, and the Z-axis antenna 11c, respectively. Specifically, the damping resistor 15a is connected to the X-axis antenna 11a, the damping resistor 15b is connected to the Y-axis antenna 11b, and the damping resistor 15c is connected to the Z-axis antenna 11c.

The switches 16a-16c are connected in series to the damping resistors 15a-15c, respectively. The switches 16a-16c are turned ON and OFF in accordance with commands from the CPU 14 so as to enable and disable the damping resistors 15a-15c, respectively.

Specifically, when the switch 16a is turned ON, the switch 16a connects the damping resistor 15a to the parallel resonance circuit formed with the capacitor 12a so that the damping resistor 15a can be enabled. In contrast, when the switch 16a is turned OFF, the switch 16a disconnects the damping resistor 15a from the parallel resonance circuit formed with the capacitor 12a so that the damping resistor 15a can be disabled.

Likewise, when the switch 16b is turned ON, the switch 16b connects the damping resistor 15b to the parallel resonance circuit formed with the capacitor 12b so that the damping resistor 15b can be enabled. In contrast, when the switch 16b is turned OFF, the switch 16b disconnects the damping resistor 15b from the parallel resonance circuit formed with the capacitor 12b so that the damping resistor 15b can be disabled.

Likewise, when the switch 16c is turned ON, the switch 16c connects the damping resistor 15c to the parallel resonance circuit formed with the capacitor 12c so that the damping resistor 15c can be enabled. In contrast, when the switch 16c is turned OFF, the switch 16c disconnects the damping resistor 15c from the parallel resonance circuit formed with the capacitor 12c so that the damping resistor 15c can be disabled.

Thus, the switches 16a-16c can serve as a switch for enabling and disabling the damping resistors 15a-15c. It is noted that the switches 16a-16c are OFF by default.

When the CPU 14 of the receiver IC 13 receives signals from two or all of the three LF antennas 11a-11c, the CPU 14 selects one LF antenna that outputs the signal having the maximum level. The LF antenna selected by the CPU 14 is hereinafter called a “selected LF antenna”. It is noted that if the CPU 14 receives a signal from only one of the LF antennas 11a-11c, the only one antenna is called the selected LF antenna.

The CPU 14 performs processing in accordance with the signal transmitted from the selected LF antenna. It is noted that the receiver IC 13 can remain activated at all times. Alternatively, the receiver IC 13 can be activated upon reception of the signal. The CPU 14 is discussed in detail below by assuming that the receiver IC 13 remains activated at all times.

The CPU 14 determines whether the selected LF antenna receives an authorized LF signal based on the signal transmitted from the selected LF antenna. Thus, the CPU 14 can serve as a determination circuit for determining whether the LF signal received by the selected LF antenna is an authorized LF signal. For example, the CPU 14 prestores a waveform of the authorized LF signal and compares a waveform of the signal transmitted from the selected LF antenna with the prestored waveform of the authorized LF signal to determine whether the selected LF antenna receives the authorized LF signal. In this case, for example, if the CPU 14 detects a signal having a waveform substantially equal to the prestored waveform within a predetermined receiving period of time, the CPU 14 can determine that the selected LF antenna receives the authorized LF signal. In contrast, if the CPU 14 does not detect the signal having the waveform substantially equal to the prestored waveform within the receiving period of time, the CPU 14 can determine that the selected LF antenna receives noise. Alternatively, the CPU 14 can determine whether the LF signal received by the selected LF antenna is an authorized LF signal or noise by a method disclosed in US 20020153995A1, which is hereby incorporated by reference.

If the CPU 14 determines that the selected LF antenna receives the authorized LF signal, the CPU 14 decides to activate the controller 17 and sends a wake-up command to the controller 17. In contrast, if the CPU 14 determines that the selected LF antenna receives noise, the CPU 14 sends a turn-ON command to a corresponding switch of the switches 16a-16c so that the corresponding switch can be turned ON. It is noted that the corresponding switch is connected to a corresponding damping resistor of the damping resistors 15a-15c and that the corresponding damping resistor is connected to the selected LF antenna. For example, in a case where the selected LF antenna is the X-axis antenna 11a, the corresponding switch is the switch 16a, and the corresponding damping resistor is the damping resistor 15a.

The controller 17 can be configured as a typical computer. Although not shown in the drawings, the controller 17 can include a CPU, a read only memory (ROM), a random access memory (RAM), an input and output (I/O) circuit, and bus lines connecting these components. The ID code of the smart mobile unit 1 and control programs of the smart mobile unit 1 can be prestored in the ROM of the controller 17. The controller 17 is waked up upon reception of the wake-up command from the CPU 14 of the receiver IC 13 and transmits the ID code prestored in the ROM to the transmitter 18. It is noted that when the controller 17 is waked up, electrical power necessary to wake up the controller 17 is supplied to the controller 17 from a battery (not shown). When the controller 17 completes necessary processing, the controller 17 sends a reset signal to the receiver IC 13 (i.e., the CPU 14) and then switches to a sleep mode.

The transmitter 18 receives the ID code of the smart mobile unit 1 from the controller 17, converts the ID code into a RF signal, and sends the RF signal to the transmitting antenna 19. Then, the transmitting antenna 19 transmits the RF signal.

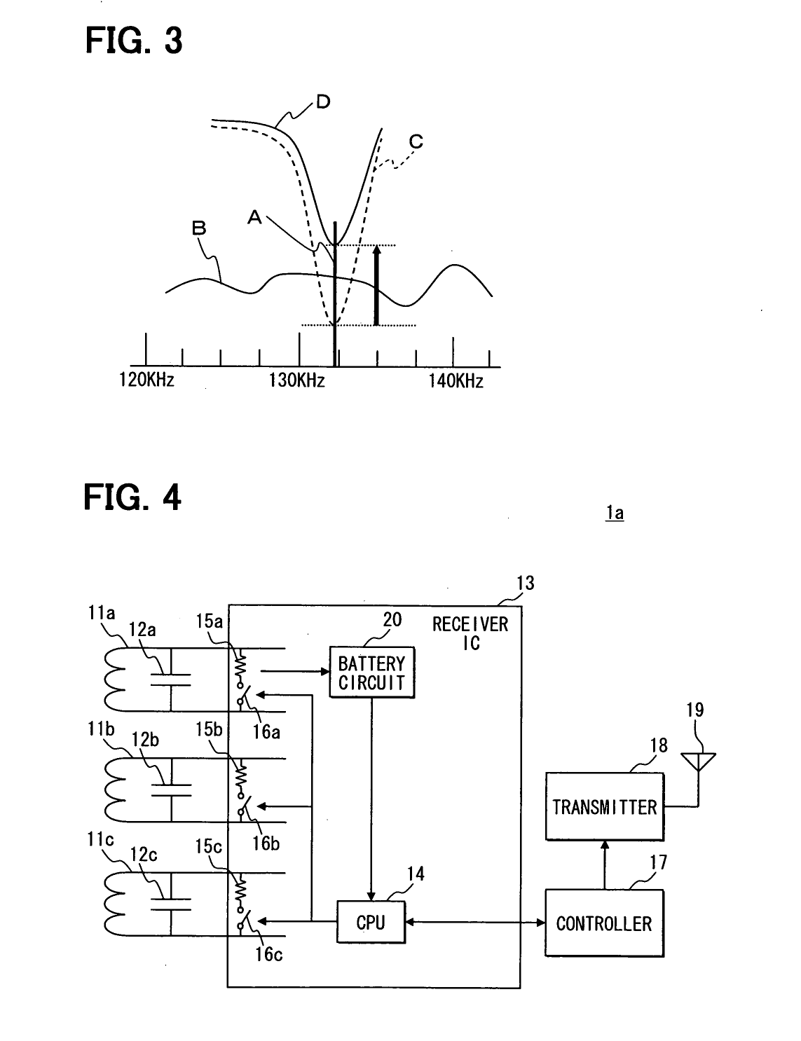

FIG. 3 is a flow diagram illustrating a process performed by the receiver IC 13. When the receiver IC 13 is supplied with a power supply voltage, the receiver IC 13 starts the process shown in FIG. 3.

The process starts at step S1, where the CPU 14 determines whether at least one of the X-axis antenna 11a, the Y-axis antenna 11b, and the Z-axis antenna 11c receives a signal. For example, at step S1, the CPU 14 determines whether to receive the signal from at least one of the X-axis antenna 11a, the Y-axis antenna 11b, and the Z-axis antenna 11c. If the CPU 14 receives the signal corresponding to YES at step S1, the process proceeds to step S2. In contrast, if the CPU 14 does not receive the signal corresponding to NO at step S1, the process repeats step S1.

At step S2, the CPU 14 selects one LF antenna that outputs the signal having the maximum level. That is, at step S2, the CPU 14 determines the selected LF antenna. Then, the process proceeds to step S3, where the CPU 14 determines whether the selected LF antenna receives an authorized LF signal based on the signal transmitted from the selected LF antenna. If the CPU 14 determines that the selected LF antenna receives the authorized LF signal corresponding to YES at step S3, the process proceeds to step S5. In contrast, if the CPU 14 determine that the selected LF antenna receives a signal different from the authorized LF signal corresponding to NO at step S3, the process proceeds to step S4.

At step S4, the CPU 14 determines whether the signal different from the authorized LF signal is received continuously for a predetermined receiving period of time. For example, the receiving period of time can be about several hundreds of milliseconds. If the CPU 14 determines that the signal different from the authorized LF signal is received continuously for the receiving period of time corresponding to YES at step S4, the process proceeds to step S6. In contrast, if the CPU 14 does not determine that the signal different from the authorized request signal is received continuously for the receiving period of time corresponding to NO at step S4, the process returns to step S1.

At step S5, the CPU 14 sends a wake-up command to the controller 17 and then waits to receive a reset signal from the controller 17. Then, when the CPU 14 receives the reset signal from the controller 17, the process returns to step S1.

At step S6, the CPU 14 turns ON a switch corresponding to a damping resistor connected to the selected LF antenna, thereby enabling the corresponding damping resistor so that the gain of the selected LF antenna can be reduced. Thus, the CPU 14 can serve as an antenna gain adjuster for reducing the gain of the LF antenna in response to a determination by the determination circuit (i.e., the CPU 14) that the LF signal received by the LF antenna is different from the authorized LF signal by controlling the switch in such a manner that the damping resistor is disabled. Specifically, if the selected LF antenna determined at step S2 is the X-axis antenna 11a, the CPU 14 turns ON the switch 16a at step S6, thereby enabling the damping resistor 15a so that the gain of the X-axis antenna 11a can be reduced. Likewise, if the selected LF antenna determined at step S2 is the Y-axis antenna 11b, the CPU 14 turns ON the switch 16b at step S6, thereby enabling the damping resistor 15b so that the gain of the Y-axis antenna 11b can be reduced. Likewise, if the selected LF antenna determined at step S2 is the Z-axis antenna 11c, the CPU 14 turns ON the switch 16c at step S6, thereby enabling the damping resistor 15c so that the gain of the Z-axis antenna 11c can be reduced. By enabling the corresponding damping resistor, the gain of the selected LF antenna can be reduced up to a value that allows the selected LF antenna can receive the authorized LF signal. For example, when the corresponding damping resistor is enabled, the gain of the selected LF antenna can be reduced by about 10 dB.

The process proceeds from step S6 to step S7, where the CPU 14 determines whether a predetermined waiting period of time is elapsed after the damping resistor is enabled at step S6. The waiting period of time can be determined based on a period of time necessary for the LF signal transmitted from the vehicle to be received by the smart mobile unit 1. For example, the waiting period of time can be about a several seconds. If the CPU 14 determines that the waiting period of time is elapsed corresponding to YES at step S7, the process proceeds to step S8. In contrast, if the CPU 14 does not determine that the waiting period of time is elapsed corresponding to NO at step S7, the process repeats step S7.

At step S8, the CPU 14 turns OFF the turned-ON switch corresponding to the enabled damping resistor connected to the selected LF antenna, thereby disabling the enabled damping resistor so that the reduced gain of the selected LF antenna can return to its original value. Specifically, if the selected LF antenna determined at step S2 is the X-axis antenna 11a, the CPU 14 turns OFF the switch 16a at step S8, thereby disabling the damping resistor 15a so that the gain of the X-axis antenna 11a can return to its original value. Likewise, if the selected LF antenna determined at step S2 is the Y-axis antenna 11b, the CPU 14 turns OFF the switch 16b at step S8, thereby disabling the damping resistor 15b so that the gain of the Y-axis antenna 11b can return to its original value. Likewise, if the selected LF antenna determined at step S2 is the Z-axis antenna 11c, the CPU 14 turns OFF the switch 16c at step S8, thereby disabling the damping resistor 15c so that the gain of the Z-axis antenna 11c can return to its original value. Thus, the CPU 14 can serve as an antenna gain resetter for resetting the reduced gain to the predetermined gain of the LF antenna by controlling the switch in such a manner that the damping resistor is disabled when a predetermined waiting period of time is elapsed after the damping resistor is enabled.

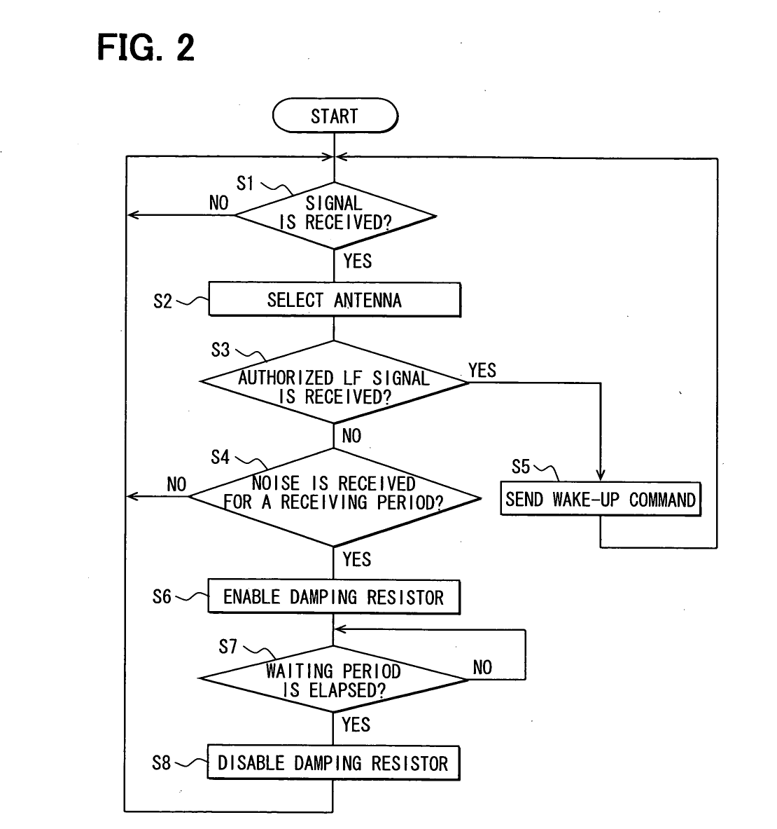

The process shown in FIG. 2 is repeatedly performed by the receiver IC 13, as long as the power supply voltage is supplied to the smart mobile unit 1. For example, the process is ended, when the battery of the smart mobile unit 1 runs down or is disconnected.

As describe above, according to the first embodiment, out of the X-axis antenna 11a, the Y-axis antenna 11b, and the Z-axis antenna 11c, only the antenna receiving noise is reduced in gain. It becomes less likely that the antenna having a reduced gain receives noise. Accordingly, it becomes less likely that the controller 17 of the smart mobile unit 1 malfunctions (i.e., is accidentally activated) due to noise. Therefore, it is possible to prevent or reduce problems that the smart mobile unit 1 cannot receive the authorized LF signal during malfunction and that the battery of the smart mobile unit 1 is wastefully used and reduced. Since a signal level of noise is generally smaller than a signal level of the authorized LF signal, the smart mobile unit 1 can receive the authorized LF signal without receiving noise.

Further, according to the first embodiment, the X-axis antenna 11a, the Y-axis antenna 11b, and the Z-axis antenna 11c are directed to different directions so that the smart mobile unit 1 can receive the signal coming from any direction. Assuming that noise comes from a specific direction, only the antenna directed to the specific direction is reduced in gain. Since the gains of the other LF antennas are kept unchanged, the total receiving area of the smart mobile unit 1 can be made as wide as possible. Therefore, when noise comes from a specific direction, and the authorized LF signal comes from a direction different than the specific direction, the smart mobile unit 1 can surely receive the authorized LF signal without receiving noise.

An advantage of the first embodiment is described in detail below with reference to FIG. 3. In FIG. 3, a longitudinal axis represents an electrical field strength, a horizontal axis represents a frequency, a graph A represents an authorized LF signal, a graph B represents wide band noise, a graph C represents a receiving frequency band of a LF antenna in which a damping resistor is disabled, and a graph D represents the receiving frequency band of the LF antenna in which the damping resistor is enabled.

When the damping resistor is disabled, the LF antenna has a high gain. Therefore, as can be seen from FIG. 3, the LF antenna represented by the graph C receives not only the authorized LF signal represented by the graph A but also the wide band noise represented by the graph B. When the damping resistor is enabled, the gain of, the LF antenna is reduced by a value represented by an arrow. As a result, the LF antenna represented by the graph D receives the authorized LF signal represented by the graph A without receiving the wide band noise represented by the graph B.

According to the first embodiment, the LF antenna has the receiving frequency band represented by the graph C by default. Then, if the LF antenna receives the noise represented by the graph B, the gain of the LF antenna is reduced so that the LF antennal can have the receiving frequency band represented by the graph D. Therefore, it is possible to prevent the LF antenna from receiving the noise represented by the graph B. It is noted that the LF antenna keeps the receiving frequency band represented by the graph C unchanged in environments where no noise exists. Therefore, the LF antenna surely receives the authorized LF signal.

The first embodiment described above can be modified in various ways, for example, as follows.

In the first embodiment, the enabled damping resistor is disabled after the predetermined waiting period of time is elapsed. The waiting period of time can be variable. For example, the CPU 14 can count a number of switching between a first condition where the damping resistor is enabled and a second condition where the damping resistor is disabled for a predetermined count period of time. In this case, if the CPU 14 determines that the counted number exceeds a predetermined count number of times, the CPU 14 can increase the waiting period of time. Thus, the CPU 14 serves as a counter for counting a number of switching between the first and second conditions and also can serve as a waiting time adjuster for increasing the waiting period of time when the counted number of switching exceeds the count number of times. The count period of time and the count number of times can be determined based on a number of times of switching between the first and second conditions when the smart mobile unit 1 is subjected to noise for a long period of time (e.g., 5 minutes or more). For example, the CPU 14 can increase the waiting period of time to several minutes.

In such an approach, if the damping resistors 15a-15c and the switches 16a-16c are frequently switched due to long exposure to noise, the waiting period of time is increased so that the number of switching of the damping resistors 15a-15c and the switches 16a-16c can be reduced. Accordingly, unnecessary processing is reduced so that processing load on the CPU 14 can be reduced.

Further, in the first embodiment, one damping resistor is connected to one LF antenna. Alternatively, multiple damping resistors can be connected to one LF antenna. Specifically, multiple damping resistors can be connected in parallel to one parallel resonance circuit. In this case, the number of enabled damping resistors can be increased each time the CPU 14 determines the LF antenna receives noise. In this way, the CPU 14 can reduce the gain of the LF antenna step by step by disabling the multiple damping resistors step by step. This step-by-step gain reduction can be reset, when the CPU 14 determines that no noise is received.

The following discussion is based on assumption that three damping resistors are connected to each of the X-axis antenna 11a, the Y-axis antenna 11b, and the Z-axis antenna 11c and that the gain of the LF antenna is reduced by 3 dB each time one damping resistor is enabled. In this case, the flow diagram of FIG. 2 can be modified as follows. When the CPU 14 determines that the X-axis antenna 11a receives noise for the first time at step S3, one of three damping resistors is enabled so that the gain of the X-axis antenna 11a can be reduced by 3 dB. Then, when the CPU 14 determines that the X-axis antenna 11a receives noise for the second time in a row at step S3, two of the three damping resistors are enabled so that the gain of the X-axis antenna 11a can be reduced by 6 dB. Then, when the CPU 14 determines that the X-axis antenna 11a receives noise for the third time in a row at step S3, all the three damping resistors are enabled so that the gain of the X-axis antenna 11a can be reduced by 9 dB. It is noted that when the CPU 14 determines that the X-axis antenna 11a receives noise for the fourth time or more in a row at step S3, all the three damping resistors remains enabled so that the gain of the X-axis antenna 11a can be reduced by 9 dB. Then, when the CPU 14 determines that no noise is received, all the three damping resistors are disabled so that the gain of the X-axis antenna 11a can return to its original value. The same holds for the Y-axis antenna 11a and the Z-axis antenna 11b.

Further, in the first embodiment, the smart mobile unit 1 is used in a smart entry system. The present invention can be applied to any types of mobile units having a controller that is activated in response to a LF signal.

Further, in the first embodiment, out of the X-axis antenna 11a, the Y-axis antenna 11b, and the Z-axis antenna 11c, only the antenna receiving noise is reduced in gain. Alternatively, when at least one of the X-axis antenna 11a, the Y-axis antenna 11b, and the Z-axis antenna 11c receives noise, all the damping resistors 15a-15c can be enabled so that all the X-axis antenna 11a, the Y-axis antenna 11b, and the Z-axis antenna 11c can be reduced in gain.

### Second Embodiment

A smart mobile unit 1a according to a second embodiment of the present invention is described below with reference to FIG. 4. For example, the small mobile unit 1a can include a power source such as a secondary battery, a capacitor, or the like.

A difference of the smart mobile unit 1a with respect to the smart mobile unit 1 of the first embodiment is that the smart mobile unit 1a has a transponder function for a so-called immobilizer system. Because of the transponder function, even if the power source of the smart mobile unit 1a runs out, the smart mobile unit 1a can be supplied with electrical power from a vehicle side antenna by wireless by holding the smart mobile unit 1a over the vehicle side antenna. Thus, the smart mobile unit 1a performs authorization by wireless communication with the vehicle to start an engine of the vehicle. For example, the vehicle side antenna can be located near an engine start switch of the vehicle.

A receiver IC 13 of the smart mobile unit 1a includes a transponder circuit (not shown) and a battery circuit 20 in addition to the CPU 14, the damping resistors 15a-15c, and the switches 16a-16c. The transponder circuit is excited (i.e., activated) by electromotive force induced in a receiving antenna by radio waves received from the vehicle side antenna. Then, the excited transponder circuit receives a signal from the vehicle side antenna through the receiving antenna. Generally, the transponder function can provide short-range wireless communication of about 2 cm to about 5 cm. For example, the X-axis antenna 11a can be used as the receiving antenna of the transponder circuit. Alternatively, the Y-axis antenna 11b or the Z-axis antenna 11c can be used as the receiving antenna of the transponder circuit.

The battery circuit 20 receives the electromotive force induced in the X-axis antenna 11a and supplies the electromotive force to the CPU 14 and the controller 17. The battery circuit 20 includes a capacitor for synchronization with the X-axis antenna 11a, an impedance matching circuit for improvement of a receiving power gain, a voltage converter for converting a voltage of the induced electromotive force, a rectifier circuit for converting AC power into DC power, a smoothing circuit for smoothing the DC power, a battery device such as a secondary battery or a large capacitance capacitor (e.g., electric double-layer capacitor) for storing the power, a charging circuit for controlling the battery device, and a limiting circuit for limiting the power supplied to the CPU 14 and the controller 17. Thus, the battery circuit 20 can serve as a battery circuit for receiving and storing electrical power transmitted from the vehicle side antenna by wireless. The CPU 14 of the smart mobile unit 1a is discussed in detail below by assuming that the battery device of the battery, circuit 20 is a large capacitance capacitor.

The CPU 14 determines whether the large capacitance capacitor is charged above a predetermined level by the battery circuit 20 to determine whether the transponder function operates to supply electrical power by wireless. Thus, the CPU 14 can serve as a charge sensor for determining whether the battery circuit 20 is charged above the predetermined level. For example, the predetermined level can be greater than a level to which the large capacitance capacitor can be charged by noise.

If the CPU 14 determines that the large capacitance capacitor is charged above the predetermined level, the CPU 14 locks all the switches 16a-16c in an OFF condition so that all the damping resistors 15a-15c can be locked in a disabled condition. Thus, the CPU 14 can serve as a transponder device for keeping the damping resistor disabled in response to a determination by the charge sensor (i.e., CPU 14) that the battery circuit 20 is charged above the predetermined level. Then, when a predetermined locking period of time is elapsed, the CPU 14 releases the lock. For example, the locking period of time can be about several hundreds of milliseconds.

In middle-range wireless communication such as wireless communication performed between the smart mobile unit 1a and the vehicle side antenna to lock and unlock the door of the vehicle according to the result of the ID code matching described in the first embodiment, it is not always necessary that the LF antenna of the smart mobile unit 1a has a high Q factor. In contrast, in short-range wireless communication such as wireless communication performed between the smart mobile unit 1a and the vehicle side antenna to achieve the transponder function described in the second embodiment, it is necessary that the LF antenna of the smart mobile unit 1a has a higher Q factor.

As described above, according to the second embodiment, the CPU 14 determines whether the transponder function operates to supply electrical power by wireless. If the CPU 14 determines that the transponder function operates to supply the electrical power by wireless, all the damping resistors 15a-15c are locked in a disabled condition. In such an approach, even if the damping resistors 15a-15c are in an enabled condition, the Q factor can return to its original value before the transponder function starts the short-range wireless communication. Thus, the transponder function can surely perform the short-range wireless communication.

In summary, in the middle-range wireless communication, the gain of the LF antenna is reduced upon reception of noise to reduce the Q factor of the LF antenna, thereby preventing malfunction caused by noise. A reason for this is that it is not always necessary that the LF antenna has a high Q factor in the middle-range wireless communication. In contrast, in the short-range wireless communication, the gain of the LF antenna is kept unchanged even upon reception of noise not to reduce the Q factor of the LF antenna. A reason for this is that it is necessary that the LF antenna has a higher Q factor in the short-range wireless communication.

(Modification)

The embodiments described above can be modified in various ways, for example, as follows. In the embodiments, the smart mobile units 1, 1a have three LF antennas 11a-11b directed to different directions. Alternatively, the smart mobile units 1, 1a can have one or two of the three antennas 11a-11c.

Such changes and modifications are to be understood as being within the scope of the present invention as defined by the appended claims.

What is claimed is:

1. A mobile unit comprising:
a LF antenna having a predetermined receiving frequency band and a predetermined gain to receive a LF signal;
a determination circuit configured to determine whether the LF signal received by the LF antenna is an authorized LF signal;
a controller configured to be activated in response to a determination by the determination circuit that the LF signal received by the LF antenna is the authorized LF signal;
a damping resistor connected to the LF antenna;
a switch configured to enable and disable the damping resistor; and
an antenna gain adjuster configured to reduce the gain of the LF antenna in response to a determination by the determination circuit that the LF signal received by the LF antenna is different from the authorized LF signal by controlling the switch in such a manner that the damping resistor is enabled.

2. The mobile unit according to claim 1, further comprising:
an antenna selector, wherein
the LF antenna comprises a plurality of antenna members,
the damping resistor comprises a plurality, of resistor members, each resistor member connected to a corresponding antenna member,
the switch comprises a plurality of switch members, each switch member configured to enable and disable a corresponding resistor member,
the antenna selector, selects one of the plurality of antenna members, the selected antenna member receiving the LF signal having the maximum signal level of all the LF signals received by the plurality of antenna members,
the determination circuit determines only whether the LF signal received by the selected antenna member is the authorized LF signal, and
the antenna gain adjuster reduces only the gain of the selected antenna in response to the determination by the determination circuit that the LF signal received by the selected antenna member is different from the authorized LF signal by controlling the corresponding switch member in such a manner that the corresponding damping resistor member is enabled.

3. The mobile unit according to claim 1, further comprising:
an antenna gain resetter configured to reset the reduced gain to the predetermined gain of the LF antenna by controlling the switch in such a manner that the damping resistor is disabled when a predetermined waiting period of time is elapsed after the damping resistor is enabled.

4. The mobile unit according to claim 3, further comprising:
a counter configured to count a number of switching between a first condition where the damping resistor is enabled and a second condition where the damping resistor is disabled for a predetermined count period of time, and
a waiting time adjuster configured to increase the waiting period of time when the counted number of switching exceeds a predetermined number of times.

5. The mobile unit according to claim 1, further comprising:
the damping resistor comprises a plurality of resistor members, each resistor member connected to the LF antenna,
the switch comprises a plurality of switch members, each switch member configured to enable and disable a corresponding resistor member, and
the antenna gain adjuster reduces the gain of the LF antenna step by step by controlling the plurality of switch members step by step in such a manner that the plurality of resistor members is enabled step by step.

6. The mobile unit according to claim 1, further comprising:
a battery circuit configured to receive and store electrical power that is transmitted from a vehicle side antenna by wireless, the vehicle side antenna mounted on a vehicle to perform wireless communication with the mobile unit;
a charge sensor configured to determine whether the battery circuit is charged above a predetermined level; and
a transponder device configured to keep the damping resistor disabled in response to a determination by the charge sensor that the battery circuit is charged above the predetermined level.
